(19) United States
(12) Patent Application Publication
(10) Pub. No.: US 2012/0188938 A1
(43) Pub. Date: Jul. 26, 2012

(54) SYSTEM AND METHOD FOR PROVIDING A LOCATION AWARE WIRELESS NETWORK

(75) Inventors: Sai Pradeep Venkatraman, Santa Clara, CA (US); Terry Fu Khan Ngo, Bellevue, WA (US)

(73) Assignee: Atheros Communications, Inc., San Jose, CA (US)

(21) Appl. No.: 13/010,172

(22) Filed: Jan. 20, 2011

(51) Int. Cl. H04W 4/02

(52) U.S. Cl. 370/328

(57) ABSTRACT

This disclosure is directed to devices and methods for providing a location aware wireless network including at least one network node that is configured to calculate a position estimate on the basis of signals received from other network nodes and to transmit location information based on the position estimate to other nodes on the network. Preferably, the network node is configured to autonomously determine a signal-derived position estimate, including those based on location information from other network nodes, signal strength or the timing of signals. Other network nodes can feature GPS receivers, which can optionally be configured to perform signal-derived estimates as well.

### FIELD OF THE PRESENT INVENTION

The present disclosure generally relates to wireless communications and more particularly relates to systems and methods for implementing a location aware network using network nodes that autonomously self locate.

### BACKGROUND OF THE INVENTION

As the number and variety of devices that are capable of communication over a wireless local area network (WLAN) glows, correspondingly there are increasing benefits associated with the determination of position information associated with nodes of the network. For example, real time location services (RTLS) have been proposed to facilitate tracking of assets and for security and emergency applications. More generally, equipping a wireless network with accurate positioning information enables improvements in the performance of the network. Further, position information can be used to supplement other location determinations, such as those utilizing Global Positioning Satellite (GPS) navigation systems.

Conventional methods of determining the position of network nodes generally rely on drive-by surveys of access points (APs) and user reports of location information with associated MAC addresses. Typically, this information is reported and stored in a database at a central location server. Thus, when a network node, such as a mobile station (STA), desires location information, it can send a request to the location server along with parameters such as AP identifiers, received signal strength indicators (RSSIs), times of arrival (TOA) or time differences of arrival (TDOA) that it has determined. The location server then utilizes the known positions of the neighbor APs and the measured signal parameters to compute the position of the requesting STA using appropriate mathematical algorithms.

As will be recognized, there are a number of shortcomings to such systems. The quality and reliability of the service is a direct function of the frequency and density of the drive-by surveys and the reliability of individual user and/or crowd-source reporting. There is also a high likelihood that the mapped APs are limited to those that are visible to the scanner along the drive routes in relatively high traffic areas while the majority of APs located in homes and inside buildings are never captured. Further, drive-by surveys cannot easily ascertain the internet protocol (IP) address of APs nor can users easily report IP address on an instantaneous and continuous basis because IP addresses are typically dynamically assigned. Additionally, this method is limited by the commercial access to the server, typically involving an expensive tariff, and is vulnerable to service outages due to loss of connection to the server or loss of the server itself.

Currently, the typical method for a network node to autonomously determine its location is through the use of an integrated GPS receiver. However, significant classes of network nodes, such as APs, rarely have GPS functionality due to the cost of including a GPS receiver. Further, since most APs are located indoors, inherent limitations of standard GPS systems, namely poor indoor visibility and accuracy, also decrease their suitability for use with these types of network nodes. For example, the signal to noise ratio of GPS signals that have to penetrate multiple walls or physical obstacles is typically too low for reliable acquisition and tracking. Similarly, multipath cause errors in the timing measurements degrade the accuracy. Moreover, network nodes within buildings tend to have a limited view of the sky which leads to high geometric dilution of precision (GDOP) of the computed position. Thus, significant portions of a typical wireless network do not have direct access to location information, either because they lack the GPS equipment or due to poor performance of the equipment if it is present.

Accordingly, what has been needed are systems and methods for directly enabling network nodes to autonomously determine location information, preferably without resorting to dedicated GPS systems. It would be desirable to provide techniques and equipment that allow network nodes to disseminate location information about themselves or other network nodes, making that information available to other network nodes, location servers or applications. It would also be desirable to enable the association of IP address and location information of network nodes. The techniques of this disclosure address these and other needs.

### SUMMARY OF THE INVENTION

In accordance with the above needs and those that will be mentioned and will become apparent below, this disclosure is directed to a method for providing location information in a wireless network including the steps of receiving a transmitted signal at a first network node from at least a second network node, receiving location information about the second network node from the network, performing a signal-based position estimation to determine location information about the first network node, and transmitting the first node location information to the network. The received signal can include location information about the second network node. The signal-based position estimate can include either or both weighting the location information based upon signal strength and calculating a timing-derived position estimation from a plurality of network nodes. Preferably, the location information is transmitted and received by incorporating the location information into management packet communication.

In one embodiment, the method also includes updating the signal-based position estimation by combining a current position estimation with a previously derived position estimation. Preferably, this occurs at a rate based upon mobility characteristics of the first and second network nodes.

In another aspect, the method also includes providing the wireless network with a database having information about network nodes and associated location information. In yet another aspect, the method includes comprising the step of correlating internet protocol address information of the first network node with the location information. In still another aspect, the method includes assigning a quality index to the location information of the first network node.

One embodiment of the disclosure is directed to providing the first network node with a GPS receiver, in which the method also includes determining location information based upon navigation satellite signals received by the GPS receiver. An additional aspect is the second network node can be GPS enabled. In such embodiment, the method includes determining location information for the GPS enabled network node based upon navigation satellite signals received by the GPS enabled network node, and transmitting location information from the GPS enabled network node to the network. Further, the method can include providing a location unaware network node, receiving a transmitted signal from the location unaware network node with the first network node, identifying the location unaware network node as lacking signal-derived position estimation capability, and transmitting information with the first network node to the network about the location unaware network node.

Location information about the first network node is transmitted to the network. In one aspect, the location information is included in a signal transmitted to a third network node.

This disclosure is also directed to a location aware wireless network node having a receiver and a transmitter wherein the receiver is configured to receive a signal from at least one additional network node, wherein the network node is configured to to obtain location information about the additional network node from the network and perform a signal-based position estimation to determine location information about the node, and wherein the transmitter is configured to send the location information about the node to the network. Preferably, the node is configured to obtain the location information about the additional from the signal received from the additional network node.

In one aspect, the node is configured to perform the signal-based position estimate using either or both weighting the location information based upon signal strength and calculating a timing-derived position estimation from a plurality of network nodes. Preferably, the node is configured to receiver and transmit location information incorporated into management packet communication.

The node is preferably configured to update the signal-based position estimation by combining a current position estimation with a previously derived position estimation. More preferably, this occurs at a rate based upon mobility characteristics of the network nodes.

In one aspect, the node is configured to correlate internet protocol address information of the network node with the location information. In another aspect, the node is configured to assign a quality index to the location information of the network node. In yet another aspect, the node further comprises a GPS receiver configured to determine location information based upon navigation satellite signals.

The disclosure is further directed to a location aware wireless network having a plurality of location aware nodes, wherein each location aware node is configured to receive signal from the network, perform a signal-based position estimation to determine location information for each location aware node, and send location information for each location aware node to the network. In one embodiment, the network includes a database having information about network nodes and associated location information. Another aspect of the disclosure involves including a GPS enabled network node configured to determine location information based upon navigation satellite signals and to transmit location information to the network. A further aspect is directed to accommodating a location unaware network node, wherein each location aware node is further configured to receive a signal from the location unaware network node with the first network node, identify the location unaware network node as lacking signal-derived position estimation capability, and transmit information to the network about the location unaware network node.

### BRIEF DESCRIPTION OF THE DRAWING

Further features and advantages will become apparent from the following and more particular description of the preferred embodiments of the invention, as illustrated in the accompanying drawing, and in which like referenced characters generally refer to the same parts or elements throughout the views, and in which:

FIG. 1 is a schematic illustration of a wireless network having nodes capable of autonomous position estimation, according to the invention.

### DETAILED DESCRIPTION OF THE INVENTION

At the outset, it is to be understood that this disclosure is not limited to particularly exemplified materials, architectures, routines, methods or structures as such may, of course, vary. Thus, although a number of such option, similar or equivalent to those described herein, can be used in the practice of embodiments of this disclosure, the preferred materials and methods are described herein.

It is also to be understood that the terminology used herein is for the purpose of describing particular embodiments of this disclosure only and is not intended to be limiting.

Unless defined otherwise, all technical and scientific terms used herein have the same meaning as commonly understood by one having ordinary skill in the art to which the disclosure pertains.

Further, all publications, patents and patent applications cited herein, whether supra or infra, are hereby incorporated by reference in their entirety.

Finally, as used in this specification and the appended claims, the singular forms “a, “an” and “the” include plural referents unless the content clearly dictates otherwise.

As discussed above, this disclosure is directed to a wireless network having location awareness, including at least one network node that is configured to calculate a position estimate on the basis of signals received from other network nodes and to transmit location information based on the position estimate to other nodes on the network. The base component of these systems is a network node, particularly an AP, that is configured to autonomously determine a signal-derived position estimate. Suitable signal-derived estimates include calculations based on location information from other network nodes, signal strength or the timing of signals as described below. Further components include network nodes that have GPS receivers, which can optionally be configured to perform signal-derived estimates as well. Finally, the systems can also accommodate network nodes that do not have signal-derived position estimation or GPS functionality.

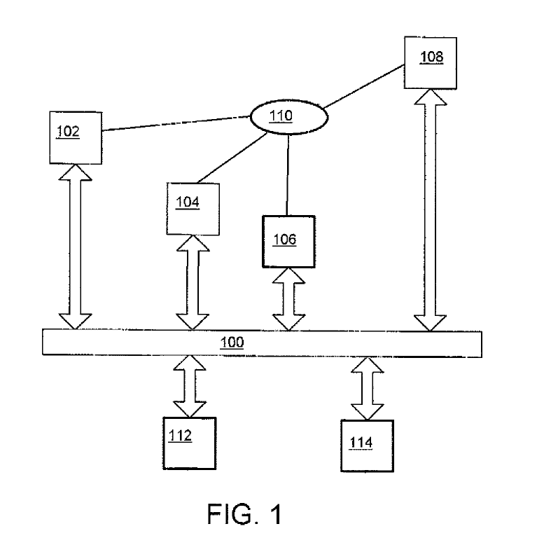

For example, FIG. 1 illustrates a representative location aware wireless network 100 including a number of nodes, including APs 102, 104, 106 and 108 and a SIA 110. Following conventional practice, STA 110 associates with one or more of APs 102-108 as shown, allowing it to communicate with network 100. In addition, network 100 can also include server 112, which may be configured to host a location database or run other suitable applications and client 114. As discussed above, network nodes such as APs 102-108 can have varying capabilities for performing signal-derived position estimates and can also be equipped with GPS receivers.

In the embodiment shown, AP 102 represents a network node having signal-derived position estimation. As discussed in further detail below, suitable signal-derived position estimates include calculations based on location information from other nearby network nodes, signal strength and signal timing. Location information about AP 102 from the signal-derived position estimate is communicated by AP 102 to the network 100, or directly to one or more network nodes, including APs 104, 106 and 108 and SIA 110. As used herein, location information includes at least a position estimation calculated by a network node and can also include aggregated position estimations for a plurality of nodes, along with other types of information, such as mobility characteristics, quality characteristics, and the others as discussed below. Preferably, AP 102 also correlates any suitable IP address information with its position estimation, including the IP address of AP 102 and any stations that may currently be associated with it. As will be appreciated from the following discussion, the dissemination of location information by AP 102 to other network nodes facilitates to subsequent location determinations by those nodes.

AP 104 represents a hybrid network node that features both signal-derived position estimation capability and GPS functionality. Accordingly, when AP 104 has good GPS signal reception, it can directly determine its location and disseminate that information to network 100. Alternatively, if GPS signal reception is not adequate, AP 104 can perform a signal-derived position estimation similar to AP 102 using the techniques described below.

Since many network nodes, such as APs, are located inside buildings the quality of GPS reception can be poor. For example, in a commercial building or office, the location of an AP is typically chosen such that an optimum number of users can receive a sufficiently strong signal. Similarly, in residential settings, such as houses or apartments, the APs are usually placed close to a cable outlet or a termination point for the high speed internet and oriented to facilitate reception throughout the house or apartment. In either situation, the AP is not usually placed with regard to GPS reception. As a result of these circumstances, a hybrid network node may often have insufficient reception of GPS signals to accurately utilize the system to determine location. In these situations, the ability to perform signal-derived position estimation is desirable. Even if a GPS signal is received, it may be of poor quality and the signal-derived position estimation can be used to confirm the accuracy of the GPS solution.

A further aspect of this disclosure is that a hybrid network node such as AP 104 can perform signal-derived position estimation to obtain location information that can be used to facilitate the GPS process. For example, the time-to-first-fix (TTFF) can be substantially reduced when a GPS receiver can predict a likely satellite constellation. Thus, even though the signal-derived position estimation is typically less accurate, a hybrid network node may be able to perform a signal-derived position estimation before obtaining a fix from the GPS satellites. As such, this location determination can be used to narrow the code search space during GPS acquisition and reduce the TIFF.

AP 106 is another example of a network node having a GPS receiver that allows it to directly determine location information. In this example, AP 106 is not configured to perform signal-derived position estimation. Thus, when the GPS receiver has access to appropriate satellite signal reception, AP 106 can accurately determine its location and transmit that information to the network 100. However, when AP 106 does not have good GPS signal reception, it cannot autonomously determine its position.

AP 108 is a legacy component that has no location awareness in the form of signal-derived position estimation or GPS functionality. Furthermore, non-location aware AP 108 is not configured to transmit any location information, either about AP 108 or other network nodes. As will be appreciated, current wireless networks have a significant proportion of nodes that share these characteristics. Since no autonomous position estimation is possible, conventional location information that is available typically results from a drive-by scan or some type of manual entry, which may be stored in a location database, such as in server 112. Further, as will be discussed in detail below, non-location aware APs can also be integrated into the location aware network.

As depicted in FIG. 1, SIA 110 is a mobile network node that associates with one or more of APs 102-108 to join the network. Further, in this example, STA 110 includes GPS functionality and is able to report its location information to the network. As described below, such location information can be used by network nodes performing signal-derived position estimation. In other implementations, SIA 110 may or may not be GPS enabled but can optionally be configured to perform signal-derived position estimations in order to determine location information that can be transmitted to location ware network 100.

Accordingly, network nodes having signal-derived position estimation capability, such as APs 102 and 104, are able to autonomously determine location based upon network nodes in range for which location information is available, such as other APs and network clients, such as client 114. Location information generally refers to the position estimates performed by the network nodes, but can also include information stored in the location server 112 and information obtained from GPS receivers. Using the techniques of this disclosure, the position of a network node at any point in time can be estimated as a function of the positions of its neighbors and any other useful parameters determined from measurements of signals propagating between the node and neighbors. The location of each capable network node is self-derived and the location awareness of the network is autonomously spread to neighboring nodes. Preferably, the position estimation is updated on an ongoing basis such that a current position estimation is combined with a previous position estimation to refine the location information. In one aspect, the combination of position estimations employs the weighting techniques discussed below.

It will be recognized that the representation of position information may be based on a standard coordinate system, such as WGS84, which results in a three dimensional position given in terms of latitude, longitude and altitude. For a wireless system that is completely contained within an enterprise or building, the positioning can also be performed in a local coordinate system. In such implementations, it is preferable that any interactions with an external system be subject to coordinate transformation so that the position information is in a format that is globally understood.

The rate at which positions of network nodes are updated is preferably based on mobility characteristics of the node from which the location updates are received. For example, if one or more GPS enabled nodes are moving in the proximity of an AP and send location updates every second, then the AP can update its location estimate rates such as once per second or lower. Alternatively, if the AP does not have any mobile GPS enabled nodes within range and receives updates only from stationary neighboring nodes, it can update its position at preferably lower rates or only if there is an indication that at least one of the neighboring APs has had a recent location update.

The updating rate of network node position can also depend on the mobility of nearby location aware users. For example, if an AP has N fixed and location aware AP neighbors and a stationary mobile user neighbor, the location updates for the AP is prefer ably controlled such that the stationary position of the mobile user is used only once for a location update and the AP then halts updates until movement of the user is detected. The movement detection can be based on a comparison of prior and current location reports from the user that shows that the user has exceeded a distance threshold.

Nodes in the network that do not have a direct source of location information use information from neighboring nodes to compute a location estimate, such as by using the position of neighboring nodes, signal strength measurements, signal timing calculations or other suitable methods of determining position. In one embodiment of the disclosure, the position of a network node is estimated from the position of neighboring network nodes as weighted by signal strength measurements, preferably RSSI. As will be appreciated, the function can take the form of a weighted centroid or weighted aver age of the neighbor positions and the previous location estimate of the AP. The weights are chosen to be proportional to the signal strength or to a distance estimate obtained from the signal strength. Suitable algorithms for obtaining distance estimates are based on the relationship between distance and signal strength that models the pathloss from the transmit entity to the receive entity.

As one example of a method for positioning a network node, at time T₀, AP P_{A} has only 2 neighboring location-aware APs, P₁ and P₂, and no neighboring mobile STAs. The weights assigned to the neighbor APs are w₁ and w₂ and their position estimates are given by 3D vectors P₁ and P₂ in a local XYZ coordinate system, thus the position estimate of A can be computed as shown in Equation (1):

$${P}_{{A}_{0}} = \frac{{w}_{1}}{{w}_{1} + {w}_{2}} {P}_{1} + \frac{{w}_{2}}{{w}_{1} + {w}_{2}} {P}_{2} \qquad ( 1 )$$

At a later time T1 when a location-aware mobile SIA, P₃, has moved within range of AP A, the location of AP A can be updated as Equation (2):

$${P}_{{A}_{1}} = \frac{{w}_{1}}{{w}_{1} + {w}_{2} + {w}_{3}} {P}_{1} + \frac{{w}_{2}}{{w}_{1} + {w}_{2} + {w}_{3}} {P}_{2} + \frac{{w}_{3}}{{w}_{1} + {w}_{2} + {w}_{3}} {P}_{3} \qquad ( 2 )$$

Furthermore, Equation (2) can be written in terms of the previous location estimate as Equation (3):

$${P}_{{A}_{1}} = \frac{{w}_{1} + {w}_{2}}{{w}_{1} + {w}_{2} + {w}_{3}} {P}_{{A}_{0}} + \frac{{w}_{3}}{{w}_{1} + {w}_{2} + {w}_{3}} {P}_{3} \qquad ( 3 )$$

As will be appreciated, a more general equation for determining the location estimate at time T_{N} can be expressed in terms of a previous estimate and the position reported by a new neighbor, P_{N}, as shown in Equation (4):

$${P}_{{A}_{N}} = \frac{{\sum }_{i = 1}^{N - 1} {w}_{i}}{{\sum }_{i = 1}^{N - 1} {w}_{i} + {w}_{N}} {P}_{{A}_{N - 1}} + \frac{{w}_{N}}{{\sum }_{i = 1}^{N - 1} {w}_{i} + {w}_{N}} {P}_{N} \qquad ( 4 )$$

The location update method described by the above equations requires that, at any time T_{N}, only the previous location estimate of the AP and the cumulative sum of the weights are required. This method ensures that all neighbor locations over time are used in determining the location of the AP.

The weighting scheme can also take into account certain quality indices and confidence factors assigned to the location estimates of the neighbors and AP. One example of a quality index is the number of “hops” between the AP and the original entity that contributed to that position estimate. In one embodiment, nodes having a direct source of location information, such as hybrid AP 104 and GPS enabled mobile STA 110, are assigned a quality index of 1. Alternatively, the hybrid network node is assigned a quality index of 1 only when signal-derived position estimation confirms the GPS solution in order to guard against an inaccurate GPS solution from corrupting the system.

Other nodes that have inferred location information derived other source are assigned correspondingly lower quality indices. For example, when an AP P_{B}, unaware of its location, has one or more neighbors of quality index 1 whose positions are used to compute a location estimate for P_{B}, P_{B} will be assigned a quality index of 2. Generally, when an AP P_{C} has multiple neighbors with multiple quality indices, it is preferable to compute its position using only the neighbors with the lowest indices, and then assign P_{C} an index one higher than that lowest index used. Alternately, P_{C} computes its position using the location estimates of all of its neighbors in a weighted manner such that lower index neighbors are assigned more importance.

The weights used in the positioning techniques of this disclosure are preferably based on range estimates derived from pathloss models. In its simplest form, a pathloss model in a wireless communication environment can be determined as shown in Equation (5):

PL=10N log₁₀(d)+S (5)

In the above equation, PL is the pathloss in decibels (Db), N is a pathloss exponent, d is the range between transmitter and receiver and S accounts for losses due to shadowing and other constant losses. The value of N ranges from 2-5 depending on the environment and is typically larger for non-line-of-sight propagation. To estimate a range from pathloss measurements, it is necessary to know the pathloss exponent. The pathloss exponent may be fixed or less dynamic in some cases such as indoor wireless networks but typically varies more dynamically in outdoor or mixed indoor/outdoor systems. When “seed” or reference devices with known locations are available, the pathloss exponent is preferably estimated in a localized manner A pathloss exponent can also be associated with each pair of reference nodes. For mobile devices, the most appropriate pathloss exponent can be assigned based on the exponents estimated for reference devices in the immediate vicinity of the mobile device.

Another suitable implementation for performing signal-derived position estimation employs timing-derived position estimations, such as measuring round trip time (RIT) or time difference of arrival (IDOA) measurements between the network node to be located and location-aware neighbors in a multilateration scheme. As will be appreciated, if signal turn-around time calibration can be performed between network nodes, RIIs can be used to obtain the ranges and when calibration cannot be performed, IDOA measurements are preferred. Further details regarding timing-derived position estimates are found in U.S. patent application Ser. No. 12/553,757, filed Sep. 3, 2009, which is hereby incorporated by reference in its entirety.

As with RSSI, a weighting scheme can be employed as desired to combine the current location estimate with the previous estimates. For three dimensional positioning, at least three neighbors are required for a timing-derived position estimation. These measurements can all be computed at the same time if a sufficient number of neighbors are available in range. Alternatively, measurements with different neighbors made at different times are used. The self-locating network node preferably performs the timing-derived position estimation measurements and computes its position using a Least squares or other well-known estimation algorithm. For this purpose, the node has to obtain and store the coordinates of the other nodes participating in the timing-derived position estimations. Alternately, the node can be configured to send the measurements to a location server 112 that computes the location and communicates it back to the node. The location server preferably has the locations of the participating entities in a database or this requisite information is sent to the server by the node along with the location request. The location estimation algorithm can incorporate available constraints on the node's location based on factors such as known altitude, relative geometry of the participating stations, network topology, coverage area of observed nodes (from initial site surveys), known street or aisles etc. While increasing the complexity of the estimation problem, this approach is feasible if desired using a location server such as server 112.

If the dilution of precision of the location estimate is high due to poor geometry between the node determining its location and neighbors, the weighted centroid method can be used as a fallback. Alternately, if one of the neighbors is a mobile STA and if a sequence timing measurements is available, the location estimation can be carried at each instant in the sequence and if the relative geometry changes with the motion of the mobile STA, the location estimate at the instant when the DOP is minimal can be assigned to the node.

In a further aspect, another suitable signal-derived position estimation technique combines timing-derived position estimation and RSSI positioning. For example, this scheme is based on the assumption that certain timing parameters can be calibrated or cancelled out. This process is facilitated if the nodes involved are made by the same manufacturer. In some cases, there may be less than 3 timing-derived position estimation measurements where the devices are from the same manufacturer. If there are additional devices in range from another manufacturer, timing-derived position estimation can be eschewed to prevent large timing errors. Accordingly, the RSSI measurements from such devices may be used along with the other timing-derived position estimation measurements in a hybrid range/range difference positioning scheme. This may be useful in situations where the RSSI measurements are from devices that are relatively close to the node that is determining its location, since RSSI can be a more reliable indicator of the true range. Further details of this process are given in U.S. patent application Ser. No. 12/553,757, which has been incorporated by reference above.

The weighting algorithms described above account for the position estimates from neighboring network nodes, such as APs and mobile STAs. However, it is desirable to ensure that erroneous estimates are filtered out as much as possible. As will be recognized, estimates have relatively low accuracy can result in a number of situations. For example, when a GPS enabled mobile STA reports an inaccurate location that is recently time stamped, such as when a GPS device used in an automobile up to a certain point in time is later brought into a building and turned on.

A suitable mechanism for minimizing the impact of this type of inaccurate location information is to compare, when available, the nodes previous location estimate and the location of nearby nodes with the position reported by the mobile STA. If the position error is greater than a pre-defined threshold, that location estimate is preferably discarded.

In another aspect, the network nodes reporting location information can include an error estimate for that measurement. For example, an AP equipped with GPS may report a location estimate with a variance of a few meters. An AP that has only one neighbor AP and has assumed the neighbors location may have a much higher error. Preferably, an intelligent filtering algorithm is used to compute and update the error estimates for the reported locations. In the weighted centroid scheme described above, one of skill in the art would expect the error variance to decrease as time progresses if multiple neighbors are available at geographic locations that are evenly distributed around the network node. Correspondingly, the positioning accuracy is directly affected by the geometry of the fixed stations as well as the accuracy of their location in timing-derived position estimations. The error estimates are also preferably factored into the weighting scheme.

Yet another aspect of the disclosure is directed to determining whether a network node has moved. As noted, the autonomous location of a network node using signal-derived position estimation is preferably followed by the network node reporting its location, so that information can be used to facilitate the location determination process of other network nodes. However, it is possible for the network node to be moved between updates to its location determination. Accordingly, the location information will be incorrect and could negatively effect the location determination of other network nodes that receive the inaccurate location information. To avoid this situation, it is desirable to monitor the integrity of the node and exclude the reported location if an error exceeding a suitable threshold is detected. In one aspect, the node monitors the integrity of the location it reports by comparing the current RSSI or range measurements from two or more known neighbors against expected values inferred from past measurements made when the reported location was known to be correct. The difference between current measurements and expected values exceeding a suitable threshold for all neighbors indicates that the node has been moved. The node preferably suspends location reports until the location estimate is updated.

As referenced above, an aspect of this disclosure is that one network node uses location information from nearby network nodes to determine a position estimate, and this determination can in turn be used by subsequent network nodes to estimate their own position. The viral nature of this process is fostered by ensuring autonomous, rapid and wide communication of location information. In one embodiment, communication of location information occurs through conventional WLAN association and transmission over network 100.

More preferably, network nodes are configured to transmit location information without requiring the more cumbersome processes and overhead associated with WLAN association, including logging on, authentication or access permission. Preferably, such communication is considered an invisible handshake, in which information is passed between the participating network nodes without requiring user intervention or repeated configuration. One suitable mechanism for transmitting location information between network nodes exploits the existing framework of management packet protocols specified by the Institute for Electrical and Electronic Engineers (IEEE) 802.11 WLAN standards. As desired, a combination of techniques can be used, including “push” based processes in which the location information is included in one or more beacon frames transmitted by the network node and “pull” based processes in which a network node initiates the communication with a probe request and receives the location information in a probe response. Push based strategies offer the further benefit of allowing the transmission of location information to multiple recipients simultaneously. Further information regarding the transfer of information using management frames is given in U.S. patent application Ser. No. 12/840,155, filed Jul. 20, 2010, which is hereby incorporated by reference in its entirety.

Although the viral positioning techniques of this disclosure are enhanced by having the network nodes report location information on a continuous basis, in some situations it can be desirable to limit the transmission of location information for the sake of efficiency. As such, in some embodiments mobile STAs are configured to report locations only when motion has been detected or when the location information has been updated. Similarly, APs may report their locations at lower rates or only upon detection of mobile STAs or other movement in their vicinity. As will be appreciated, these limitations can help to conserve battery life and to reduce the communication overhead involved in exchanging location information.

To speed up the viral location determination strategies of this disclosure, a location server 112 containing a database of network nodes and their positions is preferably employed. As a first step, nodes that have been previously discovered by surveys or reported by users may receive their location information from server 112. Upon receiving valid location information, such nodes become “seeds” which can then transmit this information to nearby nodes, allowing for subsequent position estimates by the receiving nodes.

The disclosed strategies are facilitated by a location aware wireless network 100 in which location information is easily exchanged with a goal of having effective location information for each suitable node. Accordingly, it is preferable to detect, identify and locate location unaware nodes that do not have signal-derived position estimation capabilities so that information can be made available to other nodes in the process of location determination. Thus, in currently preferred embodiments, a node reporting a list of other nodes in range is configured to identify those that do not have position estimation capabilities. Location server 112 can then estimate the location of the nodes that cannot estimate position using a database of AP identities, positions and other associated data. Alternatively, one of the network nodes, such as AP 102 or 104, can be configured to act as a local location server and perform the algorithms for providing location information for neighboring nodes that cannot perform position estimation.

As will be appreciated, the location estimate computed by such a location server can be a simple weighted average of all the neighbor locations. Further, location determinations can also be made through multilateration using range or range difference estimates determined from RSSI or timing measurements reported by nearby nodes. The computed location information can then be communicated to the neighbor nodes in the form of a local AP almanac which in turn can be shared with mobile STAs in the vicinity. Alternately, the location of nodes that cannot estimate position can be directly communicated from the location server to a mobile STA that has sent a location query. In this manner, even though location unaware nodes such as AP 108 do not actively participate in the location determination process, their location can still be determined and refined progressively as more nodes report it.

In another aspect of the disclosure, there are situations in which a network node located indoors will be in communication with other nodes, including mobile users passing into range. When the mobile node is location aware and the indoor node is not, the indoor node can assume the location reported by the mobile node as its own position as a suitable estimation. As will be recognized, the coordinates of the indoor node may correspond to a position on a street rather than indoors. Therefore, in such situations the location estimation can be refined if the indoor node has access to geographic information, such as locally stored digital maps or a location server 112 that has a map database. When the estimated position includes areas indicted as incongruous by the geographic information, such as a street, it is preferable that such locations be excluded as a possible position of the indoor node.

Other suitable means for determine if the node is indoors and thus narrow down the list of possible locations for the node. For example, the number of visible GPS satellites can be determined or the signal to noise ratio of a GPS transmission can be compared to a suitable threshold, either of which can indicate that the GPS receiver is located indoors. A sequence of mobile user RSSI measurements can also be used to detect if the user is moving towards or away from the node and this information can be used in map-matching the node's location Correspondingly, the location of the node is then corrected by matching the location coordinates to the building or a section of the building that provides the closest match. The closeness of the match can be determined by several factors not limited to proximity, type of building (for example, an office building is more likely than a parking lot), reported neighbors and the like. Similar techniques can also be applied to other situations were an external information source indicates a conflict with the estimated position.

Map matching strategies can also be used during the positioning of mobile nodes. For example, a mobile SIA in a vehicle typically receives location reports from neighboring APs or other mobile users, preferably through the management frame communication process described above. A sequence of these reports can be used to match the mobile STA to an optimal location, such as being on a street when the estimated range of locations includes incongruous positions, such as being indoors.

One of skill in the art will recognize a number of benefits that are associated with the techniques of this disclosure. For example, there can be substantial cost savings as compared to conventional node locating methods that require drive-by surveys. To the extent surveys are employed herein, only minimal surveys are used to seed and accelerate the process of location self-awareness. The disclosed techniques are also significantly more reliable as they result in the nodes continuously determining and updating their own location. In contrast, a drive-by survey captures only the information available at a single instant and does not easily updated to account for removed or moved nodes. Further, since the nodes themselves store and forward their location information, these techniques are inherently immune to any single point failure such as loss of communication to the server or loss of the server itself. Another benefit associated with this disclosure is the easy association of IP address for nodes, including APs and associated STAB, with the location of the node. This information is not available using conventional methods Cost savings are also realized by providing location information for network nodes without requiring an associated GPS receiver. Further, using these techniques, the location information is provided in indoor environments or other locations where GPS service may be poor or unavailable.

Described herein are presently preferred embodiments. However, one skilled in the art that pertains to the present invention will understand that the principles of this disclosure can be extended easily with appropriate modifications to other applications.

What is claimed is:

1. A method for providing location information in a wireless network comprising the steps of:
a) receiving a transmitted signal at a first network node from at least a second network node;
b) receiving location information about the second network node from the network;
c) performing a signal-based position estimation using the received signal to determine location information about the first network node; and
d) transmitting the location information about the first network node from the first network node to the network.

2. The method of claim 1, wherein the received signal from the second network node comprises the location information about the second network node.

3. The method of claim 1, wherein the step of performing a signal-based position estimate comprises weighting the location information about the second network node based upon signal strength.

4. The method of claim 1, wherein the step of performing a signal-based position estimate comprises calculating a timing-derived position estimation from a plurality of network nodes.

5. The method of claim 3, wherein the step of performing a signal-based position estimate further comprises calculating a timing-derived position estimation from a plurality of network nodes.

6. The method of claim 1, further comprising the step of updating the signal-based position estimation by combining a current position estimation with a previously derived position estimation.

7. The method of claim 6, wherein the step of updating the signal-based position estimation occurs at a rate based upon mobility characteristics of the first and second network nodes.

8. The method of claim 1, wherein the step of receiving a transmitted signal comprises receiving location information incorporated into management packet communication and wherein the step of transmitting location information comprises incorporating the location information into management packet communication.

9. The method of claim 1, further comprising the step of providing the wireless network with a database having information about network nodes and associated location information.

10. The method of claim 1, further comprising the step of correlating internet protocol address information of the first network node with the location information.

11. The method of claim 1, further comprising the step of assigning a quality index to the location information of the first network node.

12. The method of claim 1, wherein the first network node includes a GPS receiver, further comprising the step of determining location information based upon navigation satellite signals received by the GPS receiver.

13. The method of claim 1, wherein the location information about the second network node is based upon navigation satellite signals received by a GPS receiver associated with the second network node.

14. The method of claim 1, further comprising the steps of providing a location unaware network node, receiving a transmitted signal from the location unaware network node with the first network node, identifying the location unaware network node as lacking signal-derived position estimation capability, and transmitting information with the first network node to the network about the location unaware network node.

15. The method of claim 1, wherein the step of transmitting the location information about the first network node to the network comprises transmitting a signal to a third network node.

16. A location aware wireless network node comprising a receiver and a transmitter wherein the receiver is configured to receive a signal from at least one additional network node, wherein the network node is configured to obtain location information about the additional network node from the network and perform a signal-based position estimation to determine location information about the network node, and wherein the transmitter is configured to send the location information about the network node to the network.

17. The network node of claim 16, wherein the node is configured to obtain the location information about the additional from the signal received from the additional network node.

18. The network node of claim 16, wherein the node is configured to perform the signal-based position estimate by weighting the location information about the additional network node based upon signal strength.

19. The network node of claim 16, wherein the node is configured to perform the signal-based position estimate by calculating a timing-derived position estimation from a plurality of network nodes.

20. The network node of claim 18, wherein the node is further configured to perform the signal-based position estimate by calculating a timing-derived position estimation from a plurality of network nodes.

21. The network node of claim 16, wherein the node is thither configured to update the signal-based position estimation by combining a current position estimation with a previously derived position estimation.

22. The network node of claim 21, wherein the node is configured to update the signal-based position estimation at a rate based upon mobility characteristics of the network node and the additional network node.

23. The network node of claim 16, wherein the receiver is configured to receive location information incorporated into management packet communication and the transmitter is configured to send location information incorporated into management packet communication.

24. The network node of claim 16, wherein the node is configured to correlate internet protocol address information of the network node with the location information.

25. The network node of claim 16, wherein the node is configured to assign a quality index to the location information of the network node.

26. The network node of claim 16, further comprising a GPS receiver configured to determine location information based upon navigation satellite signals.

27. A location aware wireless network comprising a plurality of location aware nodes, wherein each location aware node is configured to receive signals having location information about network nodes from the network, perform a signal-based position estimation to determine location information for each location aware node, and send location information for each location aware node to the network.

28. The wireless network of claim 27, further comprising a database having information about network nodes and associated location information.

29. The wireless network of claim 27, further comprising a GPS enabled network node configured to determine location information about the GPS enabled network node based upon navigation satellite signals and to transmit location information about the GPS enabled network node to the network.

30. The wireless network of claim 27, further comprising a location unaware network node, wherein each location aware node is further configured to receive a signal from the location unaware network node with the first network node, identify the location unaware network node as lacking signal-derived position estimation capability, and transmit information to the network about the location unaware network node.
